(19) United States
(12) Patent Application Publication
(10) Pub. No.: US 2021/0031082 A1
(43) Pub. Date: Feb. 4, 2021

(54) THREE-DIMENSIONAL TARGET SYSTEM FOR BALL GAME SPORTS

(71) Applicant: Young Cheon CHA, Gwangju (KR)

(72) Inventor: Young Cheon CHA, Gwangju (KR)

(21) Appl. No.: 16/968,253

(22) PCT Filed: Feb. 11, 2019
(86) PCT No.: PCT/KR2019/001646

§ 371 Date: Aug. 7, 2020

(30) Foreign Application Priority Data
Feb. 9, 2018 (KR) 10-2018-0016384

(51) Int. Cl. A63B 63/06; A63B 71/06; B64C 39/02; A63B 69/36

(52) U.S. Cl. CPC A63B 63/06; A63B 71/0605; A63B 2102/32; B64C 39/024; A63B 69/36; A63B 71/0669

(57) ABSTRACT

The present invention relates to a three-dimensional target system for ball game sports and, more specifically, to a three-dimensional target system for ball game sports in which a target, suspended in midair by using a drone or a sphere, is hit. A three-dimensional hitting system using ball game sports, of the present invention has an object to be hit disposed in reality rather than in an image, thereby enabling a direct experience of a hitting sense or hitting an object against a target, such that a game can become more fun. In addition, the present invention have a drone, which is applied thereto and can be flight-controlled in midair so as to allow the object to be hit to move to various positions and return to an original position thereof, thereby enabling a user to experience a new type of game and the use of drones to increase.

### TECHNICAL FIELD

The present invention relates to a three-dimensional target system for ball game sports, and more specifically, to a three-dimensional target system for ball game sports in which a target suspended in midair using a drone or a sphere is hit.

### BACKGROUND ART

Generally, drones refer to unmanned aerial vehicles flying by induction of radio waves.

Drones were first developed for military purposes, but recently, the drones are used in various private fields such as aerial photography, transportation, disaster prevention, and security, and thus the drones are being actively developed from large fixed-wing unmanned aerial vehicles for military use to ultra-small drones for medical use.

As personal hobby activities of flying drones are increasing and as the use of drones increases for the purpose of transportation and image capturing in private fields, interest in drones is increasing. Therefore, there has been a demand for a method of further increasing the use of rotary-wing drones.

Recently, the use of drones has been diversified, such as a drone to which a protective member is attached being used in a soccer game.

Meanwhile, in indoor sports using balls, screen golf driving ranges and screen baseball driving ranges that maximize space utilization as well as indoor golf driving ranges have been increasing in recent years.

In the case of a general screen golf system, a predetermined projection device in front of a screen projects and displays images on the screen, and a hitter fixes a golf ball at a predetermined position and hits the golf ball toward a virtual space projected on the screen to carry out a golf game. Further, in the case of a screen baseball driving range, a predetermined projection device in front of a screen projects images on a screen, and when a baseball is sent to a hitter from the screen, the hitter hits the baseball to carry out a baseball game.

As described above, the golf or baseball game is actually a game that requires a large area but is applied so as to be enjoyed indoors, and thus more people may easily access the golf or baseball game.

On the other hand, a method for using a drone outdoors is mainly being sought. Therefore, in order to increase the use of drones, a system applied to indoor sports such as screen golf and soccer is required.

### DISCLOSURE

### Technical Problem

The present invention is directed to providing a three-dimensional target system for ball game sports in which an unmanned air vehicle such as a drone is used as a target in an indoor space and various types of hitting objects for hitting flying targets are used, thereby allowing the ball game sports to be enjoyed indoors.

### Technical Solution

One aspect of the present invention provides a three-dimensional target system using ball game sports. The system includes a plurality of targets located in midair in an outdoor or indoor game space, a hitting unit having a hitting object which flies in a direction of the target by an external force and applies an impact to the target, a controller configured to check and count the number of targets which are brought into contact with the hitting object and a degree of the impact and control a position of the target such that the target moved by the hitting object is moved to an original position thereof or a set position, and a target position detection unit configured to detect three-dimensional position information of the target and transmit the detected information to the controller.

The plurality of targets may each fly while maintaining a certain altitude and not moving before the hitting object comes into contact therewith and may be located adjacent to each other to form a predetermined pattern, or may be a plurality of drones flying according to a flight program set for a unit time.

The hitting object may be any one of a drone for hitting whose flight direction is adjusted via wireless communication, a sphere used for a ball game, a disc, an elastic body made of a material having elasticity, and a projectile launched by a launching device.

The three-dimensional target system using ball game sports of the present invention may further include a cushion housing which is located around the plurality of targets and has an elastic force by which the hitting object or the target is repelled in a predetermined direction when each surface of the cushion housing, which is open in a direction of the hitting object and faces the target, is brought into contact with the hitting object or the moved target.

The cushion housing may be formed in a rectangular shape which is open in a direction of the hitting object, and point holes through which the target moved by the hitting object passes may be formed in a corner side or a surface of the cushion housing.

The three-dimensional target system using ball game sports of the present invention may further include, in order for a user remotely located in a remote region to remotely check a real-time game status or to play the game by checking the number of times the hitting object has hit the target in an game space or positions of the target and the hitting object using a terminal via a communication network, a server which is connected to the controller and transmits information, such as the positions of the target and the hitting object obtained by the target position detection unit or the number of impacts of the target, to the terminal via the communication network, a game space photographing unit which is provided above the game space and transmits photographed information obtained by photographing the game space in order to check the game status, a database which is connected to the server and stores user information, game records, and the photographed information of the game space photographing unit, and a display unit which is connected to the controller and provided on one side of the game space to display the information stored in the database.

### Advantageous Effects

A three-dimensional target system using ball game sports of the present invention can have an object to be hit disposed in reality rather than in an image thereof, thereby enabling a hitting sense or hitting an object against a target to be directly experienced so that a game can become more fun.

Further, the three-dimensional target system using ball game sports of the present invention can have a drone which is applied thereto and which can be flight-controlled in midair so as to allow the object to be hit to move to various positions and return to an original position thereof, thereby enabling a user to experience a new type of game and enabling the use of drones to increase.

In addition, the three-dimensional target system using ball game sports of the present invention can accurately check positions of a plurality of targets using a three-dimensional (3D) map formed by a plurality of laser pointers so that it is possible to precisely control the movement of the plurality of targets, thereby increasing cluster flight control efficiency of the plurality of targets and furthermore, improving progress efficiency of the game.

### DESCRIPTION OF DRAWINGS

FIG. 1 is a partial perspective view of a three-dimensional target system for ball game sports according to a first embodiment of the present invention.

FIG. 2 is a block diagram of the three-dimensional target system of FIG. 1.

FIG. 3 is a partial view of coordinates formed by a target position detection unit of the three-dimensional target system of FIG. 1.

FIG. 4 is a partial front view of a three-dimensional target system for ball game sports according to a second embodiment of the present invention.

FIG. 5 is a partial front view of a three-dimensional target system for ball game sports according to a third embodiment of the present invention.

FIG. 6 is a partial front view of a three-dimensional target system for ball game sports according to a fourth embodiment of the present invention.

FIG. 7 is a partial perspective view of a three-dimensional target system for ball game sports according to a fifth embodiment of the present invention.

FIG. 8 is a partial side cross-sectional view of a position moving frame of FIG. 7.

FIG. 9 is a partial perspective view of a three-dimensional target system for ball game sports according to a sixth embodiment of the present invention.

FIG. 10 is a partial front view of a three-dimensional target system for ball game sports according to a seventh embodiment of the present invention.

FIG. 11 is a partial perspective view of a three-dimensional target system for ball game sports according to an eighth embodiment of the present invention.

### MODES OF THE INVENTION

Hereinafter, three-dimensional target systems for ball game sports according to the present invention will be described in more detail with reference to the accompanying drawings.

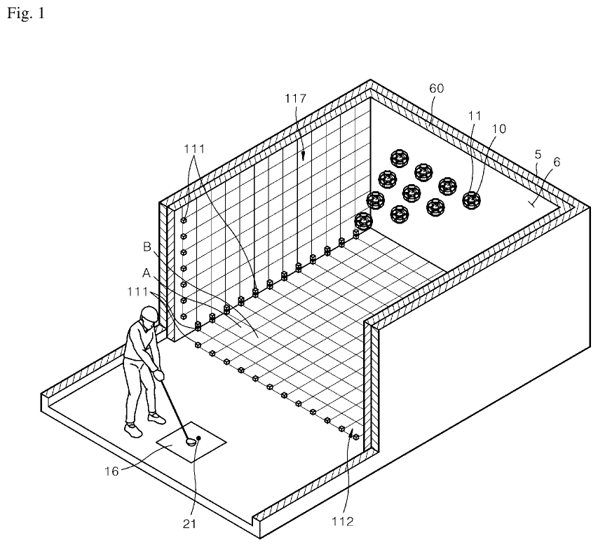

FIGS. 1 to 3 illustrate a three-dimensional target system for ball game sports according to a first embodiment of the present invention.

The three-dimensional target system for ball game sports according to the first embodiment of the present invention includes a booth 5 having a game space 6, a plurality of targets 10 located in midair in the game space 6 of the booth, a hitting unit 20 having a hitting object 21 which is flying in a direction of the target 10 due to an external force and applies an impact to the target 10, a controller 50, which counts by summing the number of targets 10 which are brought into contact with the hitting object 21 or scores or degrees of impact according to the contact and which controls a position of the target 10 such that the target 10 moved by the hitting object 21 may be moved to an original position thereof or a set position, a target position detection unit 100 which detects the position of the target 10 and transmits information about the position of the target 10 to the controller, and a special effect directing unit 70 which directs special effects in order to maximize a hitting effect.

The plurality of targets 10 each fly while maintaining a certain altitude and not moving before the hitting object 21 comes into contact therewith and are located adjacent to each other to form a predetermined pattern, or a plurality of drones flying according to a flight program set for a unit time are applied to the plurality of targets 10. Although the plurality of targets are exemplified as being arranged in a triangular shape, various arrangement forms may be applied, such as being arranged in a circular shape or irregularly arranged unlike that which is illustrated.

A circular protective member 11 for protecting the target 10 when the target 10 is hit with the hitting object 21 is provided on an outer side of the target 10. The protective member 11 may be formed of a material such as carbon fiber, expanded polypropylene, reinforced plastic, or titanium to have strength, elasticity, and flexibility. The protective member 11 has an outer shape having a spherical shape, but a structure supporting the drone may be changed according to a structure of the drone accommodated therein, unlike that which is illustrated. In the target 10, an impact detection sensor (not illustrated) which detects an impact with the hitting object 21 and transmits a sensed signal to the controller 50 is mounted. Although not illustrated, the impact detection sensor is connected to the controller 50 in a wireless communication manner through a wireless communication device (not illustrated) mounted in the drone.

The special effect directing unit 70 may be operated and controlled by the controller 50 to direct a special effect set during the game and thus may allow a user to be provided with immersion in the game and new fun. The controller 50 controls the special effect directing unit 70 to be operated when the signal is transmitted from the impact detection sensor or positions or an arrangement of the plurality of targets 10 are changed. The controller 50 recognizes position movement of the plurality of targets 10 and a change in the arrangement state of the plurality of targets 10 through information transmitted from the target position detection unit 100 which will be described below.

The special effect directing unit 70 includes a lighting unit 71 having at least one lamp which emits light under the control of the controller 50 when the hitting object 21 hits the target 10, and a speaker 73 which outputs set sounds such as shouts of spectators, announcer relay sounds, and thunder sounds when the target 10 is hit. The lamp (not illustrated) of the lighting unit 71 may be mounted on the target 10 or may be mounted on one side of the booth 5. The speaker 73 may be connected to the controller 50 and may be applied to output a voice or effect sound for a position or score of the hitting object 21 hitting the target 10 and a scoring status through the signal transmitted from the target position detection unit 100 which will be described below and the impact detection sensor.

In addition, although not illustrated, the special effect directing unit 70 may further include a scent diffusing device which is mounted on one side of the booth 5 and diffuses a specific scent when the hitting object 21 hits the target 10, a smoke generating device which generates smoke, a water spraying device which sprays water, a firework device which fires fireworks, an artificial snow spraying device which sprays artificial snow, a bubble gun which generates bubbles, and a confetti spraying device which sprays multiple pieces of confetti. As described in the lighting unit 71, the special effect directing unit 70 may be provided on an inner wall of the booth 5 or may be provided on the target 10.

As described above, when the user passes a specific mission, such as leaving a specific target 10 among the targets 10 clustered while playing the game, the three-dimensional target system for ball game sports according to the present invention may direct the special effects set in the controller 50 through the special effect directing unit 70 so that the user's immersion in the game may be increased.

Meanwhile, the impact detection sensor is preferably set to transmit different signals to the controller 50 according to the magnitude of the impact. The controller 50 may be set to detect and count a degree of impact transmitted to the target 10 according to the size of the signal of the impact detection sensor and transmit information about the counted degree to a database 58.

In addition, the hitting unit 20 may include a hitting object supply unit (not illustrated) which automatically supplies the hitting object 21, which is a sphere used in the ball game, to the hitting point 16. Although not illustrated in FIG. 1, as the hitting object supply unit, a golf ball supply device which is generally used in an indoor golf driving range may be applied.

In the three-dimensional target system according to the first embodiment of the present invention, although the hitting unit 20 using a golf ball as a hitting object is exemplified, a sphere used for ball games, such as a baseball or a soccer ball, or an arrow used for archery, or a javelin, in addition to the golf ball may be used as the hitting object in the hitting unit unlike that which is illustrated. When a baseball is used as the hitting object, the hitting object may be thrown directly to the target 10 by a person, or may be hit by a bat (not illustrated) and fly in the target direction. Further, unlike that which is illustrated, the hitting unit may be a disc-shaped disc, an elastic body made of an elastic material, or a projectile launched by a launching device such as a cannon or a gun.

In addition, the three-dimensional target system for ball game sports according to the first embodiment of the present invention includes a cushion wall 60 which is provided to cover each inner circumferential surface of the booth 5 to be located around the plurality of targets 10 and has an elastic force by which the hitting object 21 or the target 10 can be repelled in a predetermined direction when the hitting object 21 or the moved target 10 is brought into contact with each surface of the cushion wall 60 facing the target 10.

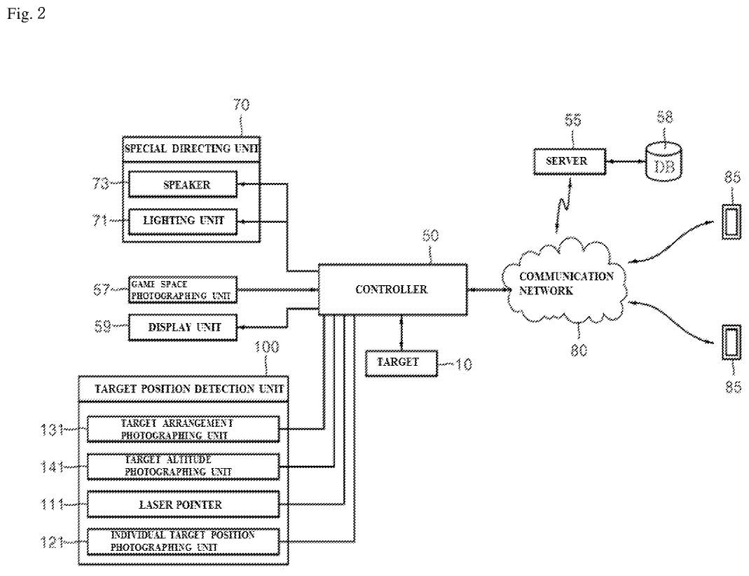

In addition, as illustrated in FIG. 2, the three-dimensional target system for ball game sports according to the present invention includes, in order for a user remotely located in a remote region to remotely check a real-time game status by checking the number of times the hitting object 21 in the booth 5 has hit the target 10 or the positions of the target 10 and the hitting object 21 using the terminal 85 via a communication network 80, a server 55 which is connected to the controller 50, stores information such as the positions of the target 10 and the hitting object 21 or the number of impacts of the targets 10, and transmits the stored information to a terminal 85, a game space photographing unit 57 which is provided above the booth 5 so that the game space 6 can be photographed, checks the game status, and transmits photographed information, which is obtained by photographing the user playing the game, obtained by continuously photographing a direction and trajectory of the target flying, or obtained by photographing the impact of the hitting object and the target, to the controller 50, the database 58 which is connected to the server 55 and stores user information, game records, and the photographed information of the game space photographing unit 57, a display unit 59 which is connected to the controller 50 and provided on one side of the booth 5 to display the information stored in the database 58, and the target position detection unit 100 which detects three-dimensional position information of the target 10 and transmits the detected information to the controller 50.

As the display unit 59, a projector which is mounted on one side of the booth 5 and projects the display information onto a front wall side of the booth 5 may be applied.

The controller 50 receives the information from the target position detection unit 100, transmits the movement information of the target 10 to the database 58 and the terminal 85 in real time via the communication network 80, and rearranges the plurality of targets 10 which have been moved in a set arrangement. The controller 50 is capable of wireless communication with a plurality of drones so that it is possible to adjust the cluster flight of the plurality of drones, and sets the plurality of drones moved by the hitting object 21 to be returned to an original position thereof or arranged in various patterns.

In the three-dimensional target system for ball game sports according to the first embodiment of the present invention, an indoor positioning system (IPS) is applied such that the controller 50 may check the position of the target and adjust the position.

The IPS that can be applied to the three-dimensional target system for ball game sports according to the first embodiment of the present invention may include at least one of a geomagnetic IPS using known geomagnetism, an inertial device-based IPS based on an inertial sensor, a still-image-based IPS using still images, a video-based IPS, a light-emitting diode (LED) lighting based IPS using an LED light source, a sonic-based IPS, and a radio-based IPS using wireless signals, or include a system combining the above systems.

Specifically, a method of using a wireless signal of a wireless device generally applied to implement a real-time location tracking system of a drone, a method of using a short-range wireless network such as beacon and Bluetooth, or a method of using photo or video image information associated with an inertial navigation device that estimates a flight path, and optical information such as infrared (IR) or visible light may be applied.

For example, in the case in which the IPS is implemented using beacon, as a method of using Bluetooth or radio-frequency identification (RFID), one or more of a method of receiving a signal from one beacon and recording information passed when a drone passes a position, a method of recording information indicating that there is a drone around the beacon location when one or several beacons are arranged for each signal range and a drone is placed around a specific beacon, and a method of receiving, by an object, an ID signal and a strength of the signal from three or more beacons and calculating and determining a position of the signal in a state in which several beacons are arranged indoors for each signal range may be applied.

The target position detection unit 100 according to the first embodiment of the present invention uses RGB-image-based position detection technology for precise position detection of the target 10 and includes a plurality of laser pointers 111, a plurality of individual target position photographing units 121, a target arrangement photographing unit 131, and a target altitude photographing unit 141.

The plurality of laser pointers 111 are provided to be spaced apart from each other at regular intervals in a width direction of the booth 5 on the bottom surface of the booth 5 at positions adjacent to the user and to apply light in a direction away from the user and are provided to be spaced apart from each other in a longitudinal direction of the booth at positions adjacent to a side walls of one side of the booth 5 and to apply light in a direction of the other side wall.

When the plurality of laser pointers 111 apply laser beams at each position of the bottom surface of the booth 5, a first pattern 112 in the form of a checkerboard is formed on the bottom surface of the booth.

The laser pointer 111 includes a first light source module (not illustrated) which has a sequence of a red laser diode, a green laser diode, and a blue laser diode in a direction parallel to the bottom surface of the booth, a second light source module (not illustrated) which is stacked on the first light source module and has a sequence of a green laser diode, a blue laser diode, and a red laser diode in a direction parallel to the bottom surface of the booth, and a third light source module (not illustrated) which is stacked on the second light source module and has a sequence of a blue laser diode, a red laser diode, and a green laser diode in a direction parallel to the bottom surface of the booth.

Each of the plurality of laser pointers 111 spaced apart from each other in the width direction of the booth on the bottom surface of the booth 5 uses the red, green, blue laser diodes of the first to third light source modules to apply laser beams of different combinations. Further, each of the plurality of laser pointers 111 spaced apart from each other in the longitudinal direction of the booth on the bottom surface of the booth 5 also applies laser beams of different combinations.

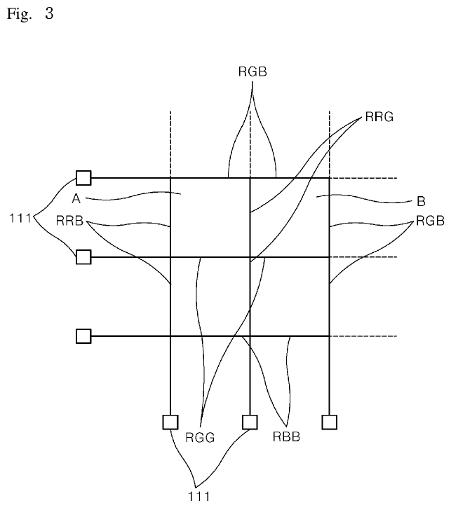

For example, referring to FIG. 3, in one laser pointer 111 among the plurality of laser pointers 111 spaced apart from each other in the width direction of the booth, the laser beam is applied from the red laser diode and the blue laser diode of the first light source module, and the red laser diode of the third light source module, and the laser beam is applied in the order of red, red, and blue (R, R, B). In addition, in the adjacent laser pointer 111, the laser beam is applied from the red laser diode of the first light source module, and the blue laser diode and the green laser diode of the third light source module, and the laser beam is applied in the order of red, blue, and green (R, B, G). In another laser pointer 111, the laser beam is applied from the red, green, and blue laser diodes of the first light source module, and the laser beam is applied in the order of red, green, and blue (R, G, B).

In addition, in one laser pointer 111 among the plurality of laser pointers 111 spaced apart from each other in the longitudinal direction of the booth, the laser beam is applied from the red laser diode and the blue laser diode of the first light source module, and the blue laser diode of the third light source module, and the laser beam is applied in the order of red, blue, and blue (R, B, B). In addition, in the adjacent laser pointer 111, the laser beam is applied from the red laser diode and the green laser diode of the first light source module, and the green laser diode of the third light source module, and the laser beam is applied in the order of red, green, and green (R, G, G). In another laser pointer 111, the laser beam is applied from the red, green, and blue laser diodes of the first light source module, and the laser beam is applied in the order of red, green, and blue (R, G, B).

In this way, a plurality of rectangular spaces are formed by the plurality of laser beams applied in the width direction and the longitudinal direction of the booth 5, and a combination of lights applied from the plurality of laser pointers forming the rectangular spaces becomes coordinates that can check a horizontal position of the target 10. Specifically, referring to FIGS. 1 and 3, coordinates of one space A become red, green, and blue (RGB), red, red, and green (RRG), red, green, and green (RGG), and red, red, and blue (RRB) in a clockwise direction, and coordinates of another rectangular space B become red, green, and green (RGG), red, red, and green (RRG), red, blue, and blue (RBB), and red, green, and blue (RGB) in the clockwise direction.

Further, the plurality of laser pointers 111 are provided to be spaced apart from each other at regular intervals in the vertical direction of the booth 5 on one side wall of the booth 5 at a position adjacent to the user and apply light in a direction away from the user, and the plurality of laser pointers 111 are provided to be located above the plurality of laser pointers 111, which are spaced apart from each other in the longitudinal direction of the bottom surface of the booth on a lower end of one side wall of the booth 5 and apply light upward.

When the plurality of laser pointers 111 apply laser beams at each position of one side wall of the booth 5, a second pattern 117 in the form of a checkerboard is formed on one side wall of the booth 5.

When the laser pointers 111 are mounted on one side wall of the booth, the laser pointers 111 are provided such that the red laser diode, the green laser diode, and the blue laser diode of the first light source module have an order in a direction parallel to one side wall of the booth.

In this way, a plurality of rectangular spaces are formed by the plurality of laser beams applied in the vertical direction and the longitudinal direction on one side wall of the booth 5, and a combination of the lights applied from the plurality of laser pointers forming the plurality of rectangular spaces becomes coordinates that can check the altitude of the target 10.

As described above, a three-dimensional (3D) map based on an RGB image is generated using the coordinates in the horizontal direction formed by the plurality of laser pointers provided on the bottom surface of the booth and using the coordinates in the vertical direction formed by the plurality of laser pointers provided on one side wall of the booth. Information of the 3D map generated as described above is stored in the controller 50 and the target 10, that is, the drone.

Alternatively, unlike that which is described above, in the plurality of laser pointers, three laser diodes of different combinations and sequences among the red laser diode, the blue laser diode, and the green laser diode are provided in a direction parallel to the bottom surface of the booth or in a direction parallel to one side wall of the booth, and thus the plurality of laser pointers may be applied to apply fixed laser beams of different combinations.

The individual target position photographing unit 121 is mounted on the target 10 to photograph a view in a vertical downward direction of the target 10 and transmits information obtained by photographing the bottom surface of the booth 5 to the controller 50. The controller 50 may receive the photographed information transmitted from the individual target position photographing unit 121 and check the position of the target 10.

The target arrangement photographing unit 131 is provided on an upper surface of the booth 5 to photograph the bottom surface of the booth 5, photographs the arrangement of the plurality of targets 10, and transmits photographed information to the controller 50. The controller 50 receives the photographed information transmitted from the target arrangement photographing unit 131 and collects coordinate information of the positions corresponding to the plurality of targets 10. The controller 50 may determine the position of the target 10 and whether the target 10 is flying according to a set formation type through the pieces of collected coordinate information and adjust the position of the target 10 which is deviated from the set arrangement.

The target altitude photographing unit 141 is provided on the other side wall of the booth 5 to photograph one side wall of the booth 5, photographs a flight altitude of the plurality of targets 10, and transmits photographed information to the controller 50. The controller 50 receives the photographed information transmitted from the target altitude photographing unit 141 and collects coordinate information of the positions corresponding to the plurality of targets 10. The controller 50 may determine whether the targets 10 are flying at a set altitude through the pieces of collected coordinate information and adjust the altitude of the target 10 which is deviated from the set altitude.

As described above, the controller 50 may collect coordinate information formed by the laser beams applied from the plurality of laser pointers 111 provided on the bottom surface and one side wall of the booth to determine a precise position of one target 10, check a flight arrangement status of the plurality of targets 10 and relative position information between the targets 10 in real time, and command and control the precise arrangement and movement of each target 10.

Further, the controller 50 may receive information about the target's departure state and movement path caused by the collision of the hitting object 21 while the game progresses, through the individual target position photographing unit 121 mounted on the target 10, the target arrangement photographing unit 131 mounted on the booth 5, and the target altitude photographing unit 141 in real time and may check and analyze flight conditions of the plurality of targets in real time. Accordingly, the controller 50 may perform control such as aggregating and scoring a set arrangement deviation of the target 10, compensating for the position of the moved target 10, or relocating the plurality of targets 10.

In addition, in the three-dimensional target system for ball game sports according to the first embodiment of the present invention, the target position detection unit 100 may include at least one of a geomagnetic sensor, an acceleration sensor, an infrared sensor, a gyroscope sensor, a proximity sensor, an acoustic sensor, an ultrasonic sensor, and the like so as to allow the controller 50 to predict the trajectory of the hitting object and allow the position to be hit or to check the position and state of the target.

In the three-dimensional target system using ball game sports according to the first embodiment of the present invention, since an object to be hit is actually placed rather than an image, the hitting of the target 10 is directly experienced by the hitting sense or the hitting object 21 and thus there is an advantage of increasing the fun of the game.

Further, in the three-dimensional target system using ball game sports according to the first embodiment of the present invention, since a drone capable of flying in midair is applied so that the object to be hit may be moved and restored to various positions, the user may experience a new type of game and have an advantage of increasing the use of the drone.

In the three-dimensional target system using ball game sports according to the first embodiment of the present invention, the positions of the plurality of targets 10 may be accurately checked through the 3D map formed by the plurality of laser pointers 111 so that it is possible to control precise movement of the plurality of targets 10, and thus it is possible to increase the efficiency of cluster flight control of the plurality of targets 10, and furthermore, there is an advantage of improving the efficiency of progressing the game.

Until now, the three-dimensional target system using ball game sports according to the first embodiment of the present invention has been exemplified as being provided in the booth having the game space indoors, but unlike that which is illustrated, a structure in which a game space is formed outdoors may be applied.

The three-dimensional target system using ball game sports according to one embodiment of the present invention may include frame-shaped first and second stands (not illustrated) in which the plurality of laser pointers 111, the target arrangement photographing unit 131, and the target altitude photographing unit 141 are provided in an outdoor space instead of the booth and which form a game space. In this case, a plurality of laser pointers 111 may be provided on a bottom surface of an outer space to be arranged in a front-rear direction based on the user at regular intervals to form a first pattern in the form of a checkerboard and may be provided to be spaced at regular intervals in the vertical direction on a first vertical frame (not illustrated) of a first stand extending vertically on one side of the game space 6 and may be provided to be spaced at regular intervals in the front-rear direction of a first horizontal frame (not illustrated) of the first stand extending in a direction away from the user at a lower end of the first vertical frame based on the user to form a second pattern in the form of a checkerboard. In this case, the target altitude photographing unit 141 may be provided on the other side of the game space to be spaced apart in a left-right direction with respect to the first stand, may be provided on the second stand forming the game space in which the plurality of targets 10 fly, together with the first stand, and may be provided to photograph the first stand side. In addition, the target arrangement photographing unit 131 may be provided to photograph the plurality of targets 10 located below and mounted on a horizontally extending frame (not illustrated) extending to connect upper ends of the first stand and the second stand.

Alternatively, in the three-dimensional target system using ball game sports according to the present invention applied outdoors, a target position detection unit using a real-time kinematic (RTK) Global Positioning System (GPS) may be applied instead of the plurality of laser pointers in order to identify the positions of the plurality of targets.

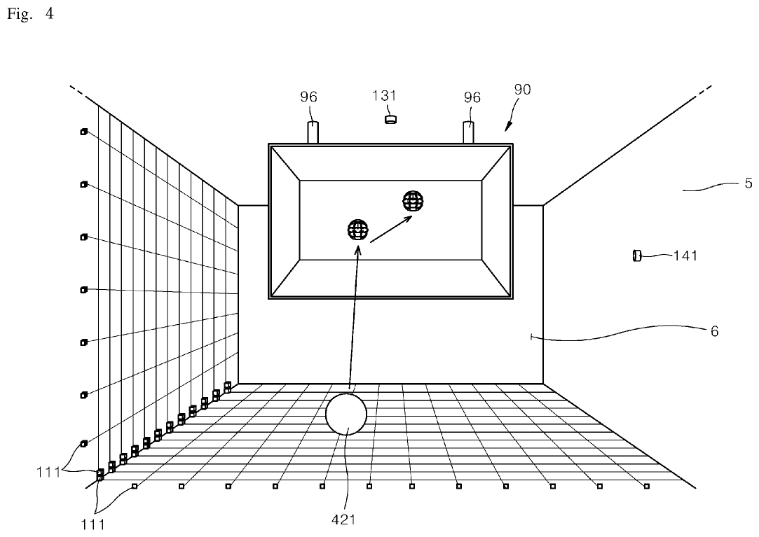

Meanwhile, FIG. 4 illustrates a three-dimensional target system for ball game sports according to a second embodiment of the present invention. The three-dimensional target system for ball game sports according to the second embodiment of the present invention further includes a cushion housing 90 in addition to the structure of the three-dimensional target system for ball game sports according to the first embodiment of the present invention. As a hitting object 221 of the three-dimensional target system for ball game sports according to the second embodiment of the present invention, a sphere used for ball games, such as a baseball or a soccer ball having a larger diameter than a golf ball, is applied.

The cushion housing 90 is formed in a rectangular shape having an inner space to be located around the plurality of targets 10 and is open in a direction of the hitting object 221 and a direction of the bottom surface of the booth 5. The cushion housing 90 is coupled to the support frame 96 extending in the vertical direction on the upper surface of the booth 5 and is located in an upper portion of the booth 5.

In addition, the cushion housing 90 is formed to have an elastic force such that the hitting object 221 or the drone may be repelled in a predetermined direction when each surface of inner circumferential surfaces of the cushion housing 90 facing the target 10 is brought into contact with the hitting object 221 or the moved target 10, that is, the drone.

The cushion housing 90 may be formed of a transparent material such that the target arrangement photographing unit 131 and the target altitude photographing unit 141 may photograph, or a plurality of through-holes (not illustrated), which are arranged in a grid shape to be spaced apart from each other, may be formed to pass through an upper surface and both side walls of the cushion housing 90. The plurality of through-holes in both side walls of the cushion housing 90 are formed at positions corresponding to each other.

However, unlike that which is illustrated, each of the target arrangement photographing unit 131 and the target altitude photographing unit 141 may be provided inside the cushion housing 90. In this case, one side wall of the cushion housing facing one side wall of the booth is transparent, or the plurality of through-holes are preferably formed therethrough in a grid shape.

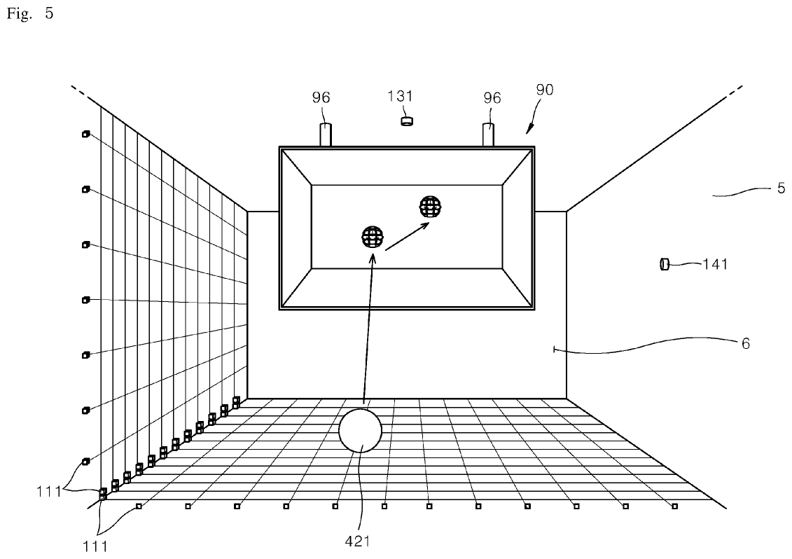

Meanwhile, FIG. 5 illustrates a three-dimensional target system for ball game sports according to a third embodiment of the present invention. The three-dimensional target system for ball game sports according to the third embodiment of the present invention includes a cushion housing 190 open only in a direction facing a hitting object 421 having a spherical shape.

Both side walls of the cushion housing 190 are transparent or the plurality of through-holes are preferably formed through the cushion housing 190 to be arranged in a grid shape such that the target arrangement photographing unit 131 and the target altitude photographing unit 141 which are provided on the inner circumferential surface of the booth 5 may photograph the target 10.

Alternatively, unlike that which is illustrated, the target arrangement photographing unit 131 and the target altitude photographing unit 141 may be mounted on an upper surface among inner circumferential surfaces of the cushion housing 190 and on the other side surface in a direction of the other side wall of the booth 5, respectively, and the plurality of laser pointers 11 may be provided to apply a plurality of laser beams such that a first pattern and a second pattern in the form of a checkerboard are formed on the bottom surface and one side surface of the cushion housing 190, respectively.

The hitting object 421 has a diameter corresponding to the protective member 11 surrounding the target 10. In the three-dimensional target system for ball game sports according to the third embodiment of the present invention, a method of scoring when the hitting object 421 hits one target 10 and then is reflected and impacted to the adjacent target 10, such as in a billiard game, may be applied.

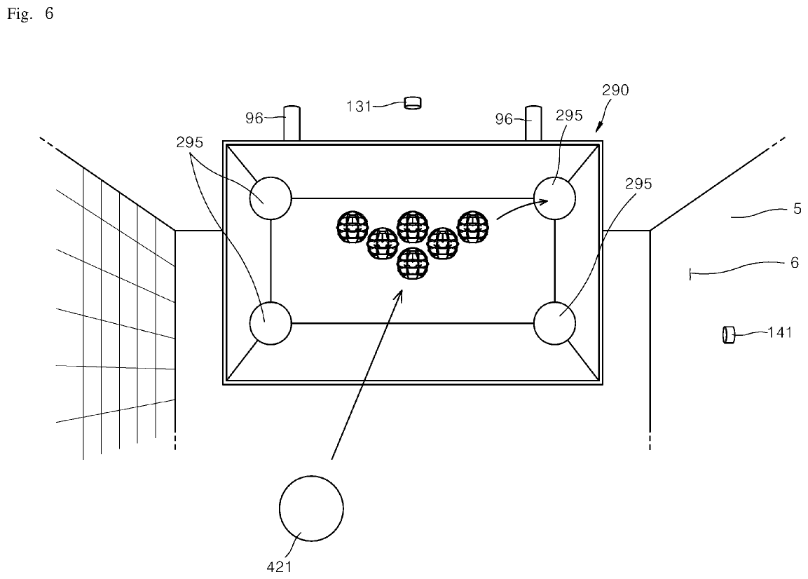

Meanwhile, FIG. 6 illustrates a three-dimensional target system for ball game sports according to a fourth embodiment of the present invention. The three-dimensional target system for ball game sports according to the fourth embodiment of the present invention further includes point holes 295 in addition to the three-dimensional target system for ball game sports according to the third embodiment of the present invention.

A cushion housing 290 is formed in a rectangular shape which is open only in a direction facing the hitting object 421, and the point holes 295 through which the target moved by the hitting object passes are formed in a corner side or a surface of the cushion housing 290.

The cushion housing 290 is not limited to the rectangular shape and may be formed in a polyhedral shape or a spherical shape.

In the three-dimensional target system for ball game sports according to the fourth embodiment of the present invention, a game method in which the hitting object hits the target 10 so that the target 10 passes through the point hole 295, such as in a pocket billiard game, may be applied.

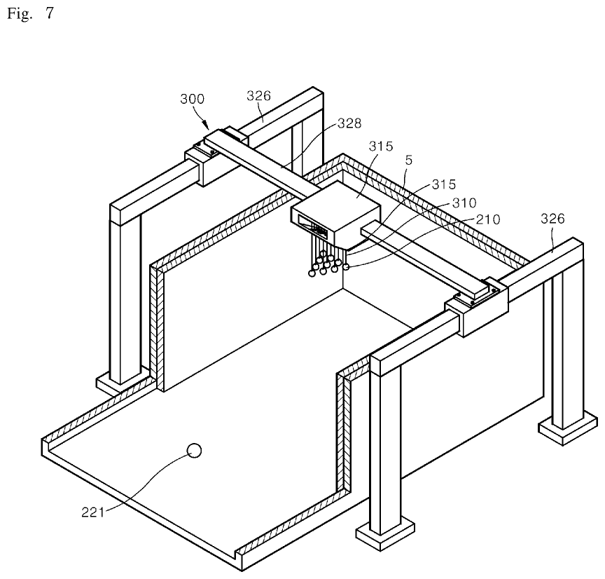

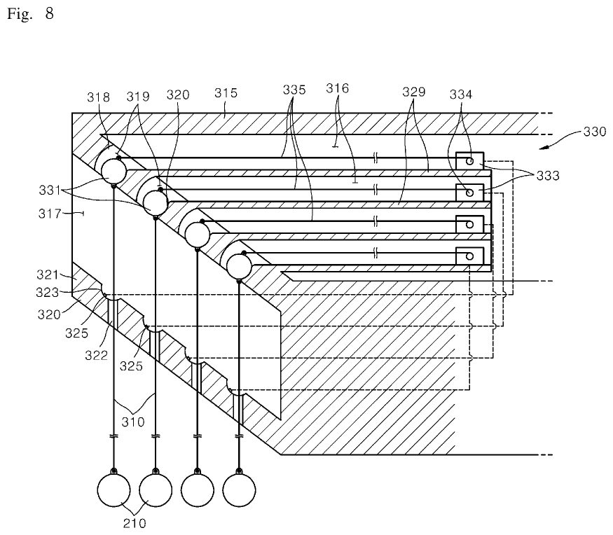

Meanwhile, FIGS. 7 and 8 illustrate a three-dimensional target system for ball game sports according to a fifth embodiment of the present invention. Components having the same function as in the drawings illustrated above are denoted by the same reference numerals.

The three-dimensional target system for ball game sports according to the fifth embodiment of the present invention includes a plurality of targets 210, a hitting object 221 hitting the target 210, a position moving unit 300 which supports the plurality of targets 210, restores the positions of the targets when the targets 210 are moved in a longitudinal or front-rear direction of the booth 5 forming a game space by impacting the hitting object 221 and the target 210, a server 55, a game space photographing unit 57, a database 58, a display unit 59, a special effect directing unit 70, and a controller 350.

The target 210 is formed in a spherical shape, and a ring for connecting with a supporting member 310 of the position moving unit 300 is formed on an upper end of the target 210. The target 210 may be one or two or more of various materials such as aluminum, steel, stainless steel, wood, plastic, resin, rubber, styrene foam, and fiber-reinforced plastic (FRP), or various shapes in addition to the spherical shape may be applied.

The position moving unit 300 includes a plurality of supporting members 310 of which one sides are connected to each ring of the plurality of targets 110 and support the connected target 110, a saddle 315 in which the other side of the supporting member is accommodated and which is provided on a ceiling side of the booth 5 and movable in the width or longitudinal direction of the booth, and a target position restoration unit 330 which is provided in the saddle 315, detects the target 110 moved by the impact with the hitting object 221 among the plurality of targets 110, and restores the position of the target 110.

Referring to FIG. 7, in order for the saddle 315 to be moved in the longitudinal or width direction of the booth, the position moving unit 300 includes a plurality of transfer guide frames 326 extending to be parallel in the longitudinal direction of the booth 5 on both side of the booth 5, a longitudinal direction moving frame 328 which extends in the width direction of the booth 5, of which both sides are slidably mounted on a plurality of transfer guide frames 321 in the longitudinal direction of the booth 5, which is provided to be movable in the longitudinal direction of the booth 5 above the inner space 6 of the booth 5, and in which the saddle is slidably mounted in the width direction of the booth 5.

Although not illustrated, on both sides of the longitudinal direction moving frame 328, a plurality of first rollers which are provided in the plurality of transfer guide frames 326 to move the longitudinal direction moving frame so that cloud movement is possible and a first roller rotating motor for rotating the plurality of first rollers are mounted. Further, on the saddle 315, a plurality of second rollers which are provided in the longitudinal direction moving frame 328 to move the saddle so that cloud movement is possible, and a second roller rotating motor for rotating the plurality of second rollers are mounted. The first and second roller rotating motors are connected to the controller 150 and controlled to move.

The supporting member 310 is a linear member formed of a bendable material such as a rope of which one side is connected to the target 210 and extends in the vertical direction and the other side facing upward is accommodated in the saddle.

The target position restoration unit 330 includes a plurality of spherical weight objects 331, which are mounted in the saddle 315, are connected to the other sides of the plurality of supporting members 310 extending into the saddle 315, and have a greater weight than the supporting members 310, a plurality of position restoring motors 333, which are mounted in the saddle and are each mounted in the saddle to correspond to the target, and a pull member 335, of which one side is connected to the weight object 331 and the other side is connected to the position restoring motor 333, and which winds or unwinds around a drive shaft according to a rotation direction of the drive shaft 334 of the position restoring motor 333.

Referring to FIGS. 7 and 8, the saddle 315 is formed to have a rectangular column shape having a thickness which decreases in a direction from a side, to which the hitting object flies, to an end thereof. In the saddle 315, a first internal space 316, in which a plurality of position restoring motors 333 and pull members 335 are accommodated, is formed. An inclined division partition 318, in which a second internal space 317 partitioned from the first internal space 316 extends downward to be formed on a side to which the hitting object flies, a plurality of weight objects 331 are mountable, and a plurality of weight object mounting holes 319 are formed to pass therethrough such that weight objects 331 are connected to the pull members and the supporting members, is formed. An inclined extension part 321, which is located below the inclined division partition 318, forms the inclined division partition 318 and the second internal space 317, and is formed to extend downward to be inclined and parallel to the inclined division partition 318, is formed.

As illustrated in FIG. 8, the first internal spaces 316 of the saddle 315 extend to be parallel in the longitudinal direction of the booth 5, are spaced apart from each other in the vertical direction, and are divided by a plurality of horizontal division partitions 329. A position restoring motor 333 is provided in a corresponding one of the plurality of horizontal division partitions 329. The plurality of position restoring motors 333 are provided in the saddle to be stacked in a triangular shape, and the number of position restoring motors 333 is increased in a direction from the horizontal division partition 329 at the top to the horizontal division partition 329 at the bottom.

In the inclined extension part 321, supporting member through-holes 322, through which the supporting members pass, extending at a position corresponding to the weight object mounting holes 319 formed thereabove are formed, and mounting grooves 323 in which the weight object 331 can be seated are formed around the upper end of the supporting member through-hole 322 to have an inner diameter greater than that of the supporting member through-hole 322.

The weight object mounting holes 319 pass through from the first internal space 316 to the second internal space 317 to be bent, and support grooves 320 in which the weight object 331 is mounted and fixed in position are formed to pass through the weight object mounting holes 319.

To allow the plurality of targets to form a triangular shape, the plurality of weight object mounting holes 319 are spaced apart from each other and are formed to pass through the inclined division partition 318 to be arranged in a triangular shape, and the plurality of supporting member through-holes 322 are also spaced apart from each other and formed to pass through the inclined extension part 321 to be arranged in a triangular shape. In addition, the plurality of position restoring motors 333 connected to the plurality of weight objects 331 are provided in the saddle to be stacked in a triangular shape.

On a bottom portion of the mounting groove 323, a push button switch 325 electrically connected to the position restoring motor 333 is provided.

The weight object 331 has a weight which is 1.2 to 1.3 times the weight of the target or more and is mounted on the weight object mounting hole 319. When an impact having a force corresponding to or a greater force than the weight object 331 is applied to the target 210, the weight object 331 is pulled downward by the supporting member 310 and lowered to the mounting groove 323 of the inclined extension part 321. The weight object 331 is lowered, and thus the supporting member 310 and the target 210 which are connected to the lowered weight object 331 are lowered by a distance by which the weight object 331 is lowered.

Meanwhile, the push button switch 325 is brought into contact with a point while being in contact with the lowered weight object 331, and a point contact signal is transmitted to the controller 350. The position restoring motor 333 is connected to the push button switch 325, is driven through the signal transmitted when the push button switch 325 is in contact with the point, and pulls the lowered target 210 to the position of the saddle 315 so that only the target 210 that is not impacted remains. In this case, the weight object 331 enters the horizontal division partition and is located adjacent to the drive shaft 334.

The controller 350 is connected to the plurality of push button switches 323, counts the number of contact points, scores the count, and transmits the score to be displayed on the display unit 59. The controller 350 operates the special effect directing unit 70 when a signal is transmitted from the push button switch 323. Accordingly, the user participating in the game may distinguish the target 210 that is not impacted by the hitting object 221 from the target that is impacted by the hitting object 221 and continues to play the game by hitting the remaining targets using the hitting object.

The position restoring motor 333 may be applied to be driven when the push button switch 325 is in contact with the point, as described above, or the position restoring motor 333 may be driven by control of the controller. The controller may drive the position restoring motor 333 corresponding to the push button switch 323, to which the signal in contact with the point is transmitted among the plurality of push button switches 323 to advance a new game, and may control all of the targets to be arranged in an initial state.

In the position restoring motor 333, a servomotor, which is configurable so that the drive shaft 334 rotates in a clockwise direction by the number of revolutions rotated in a counterclockwise direction while the weight object is lowered or configurable so that the drive shaft 334 rotates in a clockwise direction more than the number of revolutions rotated in a counterclockwise direction while the weight object is lowered such that the weight object 331 enters the horizontal division partition 329 and moves adjacent to the drive shaft 34 so that the impacted hitting object is located adjacent to the saddle 315, may be applied. The position restoring motor 333 is driven and the pull member 335 is wound around the drive shaft 334 while the drive shaft 334 is rotated in a clockwise direction, and thus the lowered weight object 331 is raised and mounted in the weight object mounting hole 319, and the positions of the supporting member 310 and the target 210 are restored.

Meanwhile, as the hitting object of the three-dimensional target system for ball game sports according to the fifth embodiment of the present invention, a drone (not illustrated) including a rotary wing and a fixed wing may be applied instead of the hitting object 221 of a sphere of a ball game. When the drone is applied as the hitting object, the drone may be used to fly in the direction of the target 210 using an acceleration force after turning the drone one or two turns. Although not shown, a separate drone launch device (not illustrated) may be used to fly the drone in the direction of the target.

In addition, unlike that which is illustrated, in the three-dimensional target system for ball game sports according to the fifth embodiment of the present invention, a large flying drone may be applied instead of the saddle 315 that is moved in the ceiling by the controller 350. Alternatively, as another embodiment of the present invention, by connecting a plurality of support rods extending in the vertical direction on a large drone and connecting a target 210 on an upper end of the support rod, the support rod gripped by the large drone when the hitting object collides with the target 210 may be applied to collapse or to release the grip.

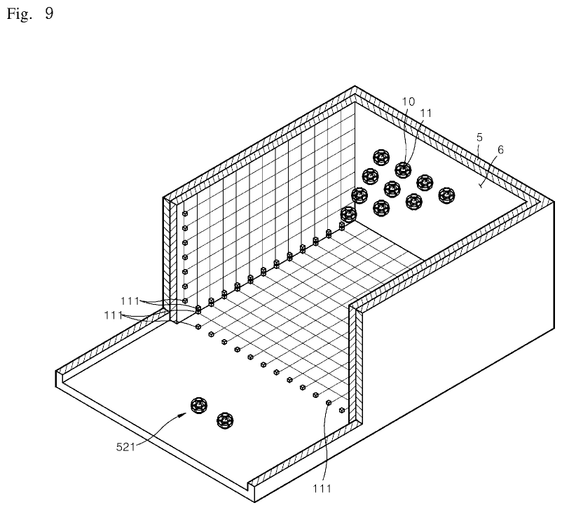

Meanwhile, FIG. 9 illustrates a three-dimensional target system for ball game sports according to a sixth embodiment of the present invention. In the three-dimensional target system for ball game sports according to the sixth embodiment of the present invention, one or more hitting drones for hitting the targets are applied as hitting objects 521 in addition to the structure of the three-dimensional target system for ball game sports according to the first embodiment of the present invention.

As described above, the drone, which is the hitting object 521 flying to the target, may be connected to a wireless controller controlled by the user via wireless communication and the flight direction may be adjusted to turn one or two turns to fly to the target 10 or may be accelerated to the target direction through an additional drone launch device (not illustrated). The hitting object 521, to which the drone is applied, may also be applicable to each of the three-dimensional target systems for ball game sports according to the second to fifth embodiments of the present invention.

In the three-dimensional target system for ball game sports according to the sixth embodiment of the present invention, the user may carry out the game while detecting the number of times the hitting object hit the target or the positions of the target and the hitting object in real time through the terminal 85 and the communication network 80 from a distance.

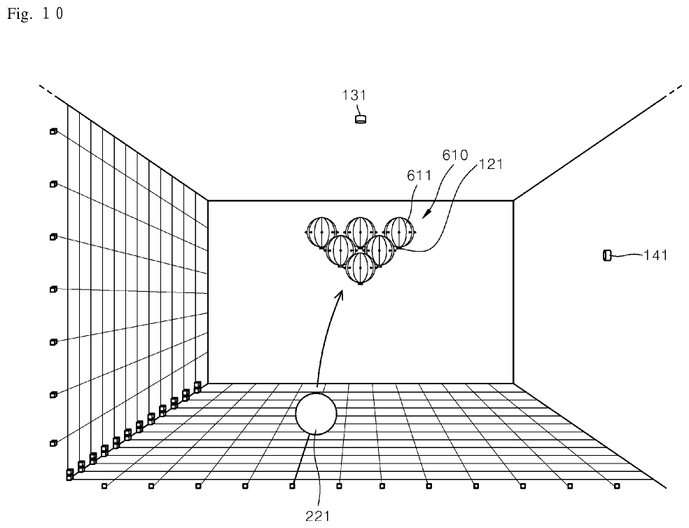

Meanwhile, FIG. 10 illustrates a three-dimensional target system for ball game sports according to a seventh embodiment of the present invention.

The three-dimensional target system for ball game sports according to the seventh embodiment of the present invention has the same structure as the structure of the three-dimensional target system for ball game sports according to the first embodiment of the present invention excluding a hitting unit to which the drone 521 is applied, a balloon body 611 having an inner space filled with a gas so as to have a set shape, and a target 610 to which a drone that can fly is applied for position movement by the controller 50.

An individual position photographing unit 121 is mounted on a lower end of the target 610. The balloon body 611 is not limited to the illustrated shape, and various shapes may be applied. Further, although not illustrated, in the balloon body 611, a liquid filling space filled with liquid so as to cushion the impact when colliding with the hitting object on the outside may be provided.

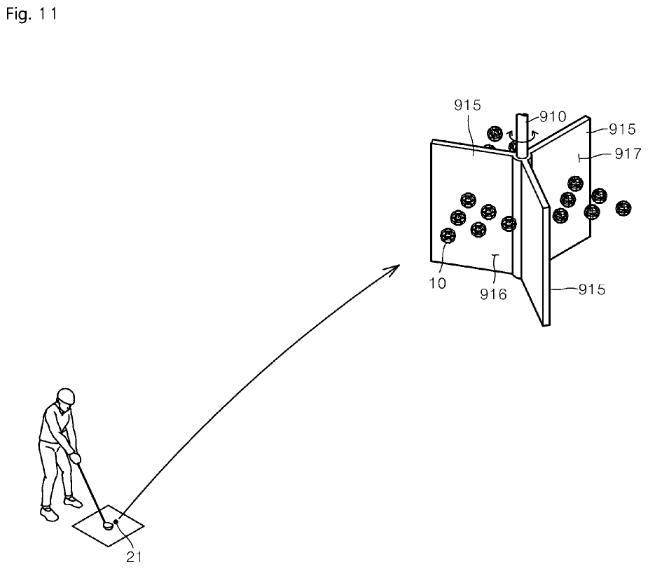

Meanwhile, FIG. 11 illustrates a three-dimensional target system for ball game sports according to the eighth embodiment of the present invention. The three-dimensional target system for ball game sports according to the eighth embodiment of the present invention includes a plurality of targets 10 divided into a plurality of groups and further includes a consecutive hit housing unit 900 having a plurality of partitions 915 that partition a space to separate the plurality of groups in addition to the structure of the three-dimensional target system for ball game sports according to the first embodiment of the present invention.

The consecutive hit housing unit 900 includes a rotation shaft 910 rotatable in a predetermined space in which the plurality of targets 10 fly in the booth 5, and a plurality of partitions 915 extending radially from the rotation shaft 910 to divide the predetermined space into the plurality of partition spaces 918 such that the plurality of targets 10 may be divided into the plurality of groups.

The consecutive hit housing unit 900 is rotated after the first partition space 916 facing the hitting object 21 is hit so that the adjacent second partition space 917 is rotated to face the hitting object 21 and thus allows the user to hit consecutively.

Meanwhile, although not illustrated, a three-dimensional target system for ball game sports according to one embodiment of the present invention may further include a display device for three-dimensionally displaying a stadium or field image for each ball game corresponding to the hitting objects 21, 221, and 421, a trajectory of the hitting objects 21, 22, and 421, or the way the user is playing in three-dimensional graphics, displaying a game progressing method in which virtual reality (VR) and augmented reality (AR) systems are applied, showing the shapes of the targets 10 and 210 and the hitting objects 21, 221, and 421 in addition to the three-dimensional image, or displaying stereoscopic images in the air using interference of light. For example, the trajectory of the hitting object may be calculated using various types of sensors or cameras described above, and the projected trajectory may be displayed on the screen using a projector (not illustrated) or may be displayed on display devices, such as a head mounted display (HMD), VR goggles, glasses, a helmet, and a liquid-crystal display (LCD) as a virtual three-dimensional image.

While the present invention has been described with reference to the embodiment illustrated in the accompanying drawings, the embodiment should be considered in a descriptive sense only, and it should be understood by those skilled in the art that various alterations and equivalent other embodiments may be made. Therefore, the scope of the present invention should be defined by only the following claims.

1. A three-dimensional target system for ball game sports, the system comprising:
a plurality of targets located in midair in an outdoor or indoor game space;
a hitting unit having a hitting object which flies in a direction of the target by an external force and applies an impact to the target;
a controller configured to check and count the number of targets which are brought into contact with the hitting object and a degree of the impact and control a position of the target such that the target moved by the hitting object is moved to an original position thereof or a set position; and
a target position detection unit configured to detect three-dimensional position information of the target and transmit the detected information to the controller.

2. The system of claim 1, wherein the plurality of targets each fly while maintaining a certain altitude and not moving before the hitting object comes into contact therewith and are located adjacent to each other to form a predetermined pattern, or are a plurality of drones flying according to a flight program set for a unit time.

3. The system of claim 1 or 2, wherein the hitting object is any one of a drone for hitting whose flight direction is adjusted via wireless communication, a sphere used for a ball game, a disc, an elastic body made of a material having elasticity, and a projectile launched by a launching device.

4. The system of claim 1, further comprising a cushion housing located around the plurality of targets,
wherein the cushion housing has an elastic force by which the hitting object or the target is repelled in a predetermined direction when each surface of the cushion housing, which is open in a direction of the hitting object and faces the target, is brought into contact with the hitting object or the moved target.

5. The system of claim 4, wherein the cushion housing is formed in a rectangular shape which is open in a direction of the hitting object, and point holes through which the target moved by the hitting object passes are formed in a corner side or a surface of the cushion housing.

6. The system of claim 1, further comprising, in order for a user remotely located in a remote region to remotely check a real-time game status or to play the game by checking the number of times the hitting object has hit the target or positions of the target and the hitting object using a terminal via a communication network:
a server which is connected to the controller and transmits information, such as the positions of the target and the hitting object obtained by the target position detection unit or the number of impacts of the target, to the terminal via the communication network;
a game space photographing unit which is provided above a game space and transmits photographed information obtained by photographing the game space in order to check the game status;
a database which is connected to the server and stores user information, game records, and the photographed information of the game space photographing unit; and
a display unit which is connected to the controller and provided on one side of the game space to display the information stored in the database.

7. The system of claim 1, wherein the target position detection unit includes:
a plurality of laser pointers which are provided to be spaced apart from each other at regular intervals in a width direction of the game space on a bottom surface of the game space at positions adjacent to a user and apply light in a direction away from the user and are spaced apart from each other at regular intervals in a longitudinal direction of the game space on one side of the game space and apply light in a direction of the other side to form a first pattern in the form of a checkerboard;
an individual target position photographing unit which is mounted on the target to photograph a view in a vertical downward direction of the target and transmits information obtained by photographing the bottom surface of the game space to the controller; and
a target arrangement photographing unit which is provided above the game space to photograph a view in a downward direction, photographs an arrangement of the plurality of targets, and transmits photographed information to the controller,
wherein the plurality of laser pointers apply laser beams of different combinations and sequences in a longitudinal direction and a width direction of the bottom surface of the game space so that the first pattern forms coordinates to check the position of the target.

8. The system of claim 7, wherein the plurality of laser pointers are further provided to be spaced apart from each other at regular intervals in a vertical direction of the game space on one side of the game space and apply light in a direction away from the user and are further provided to be located above the plurality of laser pointers, which are spaced apart from each other in the longitudinal direction of the bottom surface of the game space on a lower end of one side of the game space and apply light upward to form a second pattern in the form of a checkerboard on one side of the game space, and
the plurality of laser pointers includes a target altitude photographing unit which is provided on the other side of the game space to photograph one side of the game space, photographs flight altitudes of the plurality of targets, and transmits photographed information to the controller.

9. A three-dimensional target system for ball game sports, the system comprising:
a plurality of targets located in midair in an indoor or outdoor game space;
a hitting unit having a hitting object which flies in a direction of the target by an external force and applies an impact to the target;
a controller configured to check and count the number of targets which are brought into contact with the hitting object and control a position of the target such that the target moved by the hitting object is moved to an original position thereof or a set position; and
a position moving unit configured to support the plurality of targets to move the target in a longitudinal or width direction of the game space, support the target to be lowered when the hitting object and the target are impacted, and restore the position of the lowered target,
wherein the position moving unit includes a plurality of supporting members of which one sides are connected to the plurality of targets and support the plurality of targets,
a saddle in which the other side of the supporting member is accommodated and which is provided above the game space and movable in the width or longitudinal direction of the game space, and
a target position restoration unit which is provided in the saddle, detects the target moved by the impact with the hitting object among the plurality of targets, and restores the position of the target.

10. The system of claim 9, wherein the target position restoration unit includes:
a plurality of spherical weight objects which are mounted in the saddle, are connected to the other sides of the plurality of supporting members extending into the saddle, and have a greater weight than the supporting members so that the plurality of spherical weight objects are lowered when an impact having a force corresponding to or a greater force than the weight object is applied to the target;
a plurality of position restoring motors which are mounted in the saddle and are each mounted in the saddle to correspond to the target; and
a pull member of which one side is connected to the weight object and the other side is connected to the position restoring motor, and which winds or unwinds around a drive shaft according to a rotation direction of the drive shaft of a position restoration motor.

11. The system of claim 1, further comprising a consecutive hit housing unit including:
a rotation shaft rotatable in the game space in which the plurality of targets fly; and
a plurality of partitions extending radially from the rotation shaft to divide the game space into a plurality of partition spaces such that the plurality of targets are divided into a plurality of groups,
wherein the consecutive hit housing unit is rotated after the partition space facing the hitting object is hit so that the adjacent second partition space is rotated to face the hitting object.
